(19) United States
(12) Patent Application Publication
(10) Pub. No.: US 2025/0176507 A1
(43) Pub. Date: Jun. 5, 2025

(54) NOVEL METHODS OF AQUACULTURE

(71) Applicant: AQUAMAOF AQUACULTURE TECHNOLOGIES LTD., Rosh HaAyin (IL)

(72) Inventors: Gary MYERS, Plano, TX (US); Neder SNIR, Limassol (CY)

(73) Assignee: AQUAMAOF AQUACULTURE TECHNOLOGIES LTD., Rosh HaAyin (IL)

(21) Appl. No.: 18/727,402

(22) PCT Filed: Jan. 9, 2023
(86) PCT No.: PCT/IL2023/050028

§ 371 Date: Jul. 9, 2024

Related U.S. Application Data
(60) Provisional application No. 63/266,600, filed on Jan. 10, 2022.

(51) Int. Cl. A01K 63/04; A01K 61/10

(52) U.S. Cl. CPC A01K 63/04; A01K 61/10

(57) ABSTRACT

Novel processes for managing concentrations of free gas CO₂ in aquaculture systems, maintaining health and quality of the aquatic organisms and reducing costs of aquaculture systems are provided.

### TECHNICAL FIELD OF THE INVENTION

The invention relates to the field of aquaculture. More specifically, the invention relates to novel processes for managing concentrations of free gas CO₂ in aquaculture systems.

### BACKGROUND OF THE INVENTION

Water quality is crucial in fish farming, as poor quality water can effect the health and growth of the fish.

Water quality can quickly decline in fish ponds as fish use the water to live, feed, reproduce, grow and excrete waste into. Fish farmers who wish to be successful should therefore to be aware of water quality of their system, the needs of the fish and, to successfully manage water quality factors.

Dissolved gases are one of the major factors influencing water quality, while the most common gases are oxygen, carbon dioxide (CO₂), nitrogen, and ammonia.

Increased CO₂ in the water results in reduction of the rate at which CO₂ from the fish's own metabolism can be released from the blood through the gills. Thus is known as hypercapnia, resulting in a drop in the blood pH, and acidosis. At the same time the oxygen-carrying ability of the hemoglobin in the blood is reduced. In the short term the physiology of the fish can counteract the effect by balancing the acidosis with an exchange of ions such as increasing the uptake of bicarbonate and losing hydrogen and phosphate ions and little harm is done. In the long term this balancing act can have a more profound effect on the health of the fish. Long term effect can cause nephrocalcinosis, a kidney disease that impacts fish quality and growth.

CO₂ concentration in recirculating aquaculture systems (RAS) is a critical factor for maintaining fish health. Fish and bacteria both produce CO₂ as part of normal fish growth and normal bacterial growth in RAS operations. CO₂ is released from the fish and bacteria and becomes dissolved in the system water. A portion of the total released CO₂ dissolves in and chemically reacts with the water.

Current practice of RAS operation is based on bubbling air into the water or spraying water through a continuous air flow, to remove the dissolved portion of CO₂, thereby reducing the concentration of CO₂ in the system water to maintain concentration of CO₂ within healthy limits (acceptable CO₂ concentration depends upon the fish species). Typical CO₂ stripping (degassing process) methods used for RAS remove 70% to 90% of the dissolved CO₂ as measured by calculating the difference in CO₂ concentration from the inlet to the outlet of the CO₂ stripping element. The actual mg/liter CO₂ removed is then the quantity of CO₂ than can be added by fish and bacteria in the next cycle of water recirculation. For example, assuming fish tank outlet water with 12 mg/liter CO₂ and the CO₂ concentration after stripping (removal) of 2 mg/liter, then the removal is 10 mg/liter considered as 83% removal efficiency. Therefore 10 mg/liter CO₂ can be added in the next cycle of water flow through the fish tank.

Small increases in free gas CO₂ above optimum levels in aquaculture systems have been shown to negatively impact fish growth rates. State of the art techniques for controlling and maintaining free CO₂ gas in aquaculture systems rely on increasing the water exchange rate in an aquaculture tank which increases cost of construction and operating cost of the entire facility.

Providing efficient methods for managing concentrations of free gas CO₂ in aquaculture systems remains a long and unmet need.

### SUMMARY OF THE INVENTION

Accordingly, it is a principal object of the present invention to provide new method for CO₂ control in aquaculture.

According to some embodiments, the present invention enables reduction of water exchange rates and allows for increased quantity of fish in the aquaculture system without increasing the water exchange rate. Both concepts result in lower cost of construction and lower operating costs per unit of aquaculture production.

According to some embodiments, the invention combines methods for increasing the portion of CO₂ that chemically reacts with the system water (only the CO₂ remaining as dissolved gas is toxic to fish) and then providing gas stripping element in the RAS that removes dissolved gas CO₂ and removes the portion of added CO₂ that reacted with the water in the aquaculture tank.

According to some embodiments, the proposed method intentionally increases the carbonate alkalinity concentration of the system water which increases the quantity of CO₂ that chemically reacts with the water, thereby converting, within seconds, a larger portion of CO₂ released by fish to non-toxic forms.

According to some embodiments, the proposed method/process enables the system water to remain in the fish tank for a longer period accumulating more released CO₂ thereby allowing for lower water recirculation rates. Lower water recirculation rates result in lower electrical costs for water pumping and lower capital costs for water treatment elements.

According to some embodiments, the invention provides a process of maintaining a desired free gas CO₂ concentration in an aquaculture tank of an aquaculture system, comprising adjusting carbonate alkalinity levels to the level of 150 mg/l to 5000 mg/l in the aquaculture tank by adding a carbonate alkalinity adjusting agent into the tank, wherein the aquaculture tank comprises an amount of an aquatic organism, and wherein said aquatic organism produces free gas CO₂, and wherein the aquaculture system is configured to remove CO₂ from the water.

According to some embodiments, the invention provides a method of aquaculture in a RAS system, comprising maintaining a desired free gas CO₂ concentration in an aquaculture tank, wherein the maintaining the desired free gas CO₂ concentration comprises adjusting carbonate alkalinity levels to the level of 150 mg/l to 5000 mg/l in the aquaculture tank by adding a carbonate alkalinity adjusting agent into the water.

According to some embodiments, the invention provides a method of reaching a desired ratio of a biomass density to the amount of water processed through a water treatment process in an aquaculture tank, comprising adjusting alkalinity levels to the level of 150 mg/l to 5000 mg/l in the aquaculture tank by adding an alkalinity adjusting agent into the water, wherein the biomass is an aquatic organism biomass, and wherein the aquatic organism biomass produces free gas CO₂.

According to some embodiments, the invention provides a method of aquaculture comprising maintaining the free gas CO₂ concentration produced by a biomass of aquatic organisms under a desired threshold by adjusting carbonate alkalinity levels to the level of 150 mg/l to 5000 mg/l in an aquaculture tank by adding an alkalinity adjusting agent into the water.

Additional features and advantages of the invention will become apparent from the following drawings and description.

### DETAILED DESCRIPTION OF THE INVENTION

Before explaining at least one embodiment of the invention in detail, it is to be understood that the invention is not limited in its application to the details of construction and the arrangement of the components set forth in the following description. The invention is applicable to other embodiments or of being practiced or carried out in various ways. Also, it is to be understood that the phraseology and terminology employed herein is for the purpose of description and should not be regarded as limiting.

According to some embodiments, the invention provides a process of maintaining a desired free gas CO₂ concentration in an aquaculture tank of an aquaculture system. As used herein, the term “maintaining” refers, without limitation to taking an action or a set of actions leading to the desired effect, namely, desired free gas CO₂ concentration. In the context of the invention, the term “maintaining” is meant to be understood as and interchangeable with terms such as “controlling”, or “manipulating”. According to some embodiments, the term “adjusting” refers to increasing, decreasing, and/or maintaining the alkalinity levels. As used herein, the term “desired free gas CO₂ concentration” refers to concentration which can be well tolerated by the aquatic organism and/or allows cost-effective and efficient operation of the aquaculture system. The tolerated concentration acceptable in aquaculture ranges from 0.5 mg/l to 50 mg/l. In the context of the invention, the term “desired” is meant to be understood, without limitation, as “preset”, “predefined”, “preferred”, “needed”, “wanted”, “required”, “specific”, and “certain”.

According to some embodiments, the above process comprises adjusting carbonate alkalinity levels to the level of 150 mg/l to 5000 mg/l in the aquaculture tank by adding a carbonate alkalinity adjusting agent into the tank, wherein the aquaculture tank comprises an amount of an aquatic organism, and wherein said aquatic organism produces free gas CO₂, and wherein the aquaculture system is configured to remove CO₂ from the water. As used herein, the term “adding” is meant to be understood as any direct or indirect application of the alkalinity adjusting agent according to the embodiments of the invention to the water in any state, whether, without limitation, in a liquid state or as a solid.

In the context of the invention, the term “alkalinity adjusting agent” and “carbonate alkalinity” refer, without limitation, to any naturally occurring carbonate alkalinity source, biologically active agent, chemical compound, enzyme compound, electrical action, or any combination thereof. A non-limiting list of carbonate alkalinity adjusting agents of the invention includes: sodium bicarbonate, sodium hydroxide, sodium carbonate, calcium hydroxide, calcium oxide, calcium carbonate, dolomite magnesium hydroxide, magnesium carbonate, electrolysis of salt water, and an enzymatic reactions.

According to some embodiments the above process comprises adjusting alkalinity levels to the level of 150 mg/l to 5000 mg/l; 250 mg/l to 1000 mg/l; 500 mg/l to 1000 mg/l. In the context of the invention, the alkalinity can be measured in a laboratory using a water sample (0.5 to 1.0 liters collected from the water in the fish tank). The laboratory methods for alkalinity are well established prior art using standardized acid titration to measure the pH buffering capacity of the water.

According to some embodiments the above process comprises adjusting alkalinity levels to the level of 150 mg/l; 200 mg/l; 250 mg/l; 300 mg/l; 350 mg/l; 400 mg/l; 450 mg/l; 500 mg/l; 550 mg/l; 600 mg/l; 650 mg/l; 700 mg/l; 750 mg/l; 800 mg/l; 850 mg/l; 900 mg/l; 950 mg/l; 1000 mg/l; 1150 mg/l; 1200 mg/l; 1250 mg/l; 1300 mg/l; 1350 mg/l; 1400 mg/l; 1450 mg/l; 1500 mg/l; 1550 mg/l; 1600 mg/l; 1650 mg/l; 1700 mg/l; 1750 mg/l; 1800 mg/l; 1850 mg/l; 1900 mg/l; 1950 mg/l; 2000 mg/l; 2150 mg/l; 2200 mg/l; 2250 mg/l; 22300 mg/l; 2350 mg/l; 2400 mg/l; 2450 mg/l; 2500 mg/l; 2550 mg/l; 2600 mg/l; 2650 mg/l; 2700 mg/l; 2750 mg/l; 2800 mg/l; 2850 mg/l; 2900 mg/l; 2950 mg/l; 3000 mg/l; 3150 mg/l; 3200 mg/l; 3250 mg/l; 3300 mg/l; 3350 mg/l; 3400 mg/l; 3450 mg/l; 3500 mg/l; 3550 mg/l; 3600 mg/l; 3650 mg/l; 3700 mg/l; 3750 mg/l; 3800 mg/l; 3850 mg/l; 3900 mg/l; 3950 mg/l; 4000 mg/l; 4150 mg/l; 4200 mg/l; 4250 mg/l; 4300 mg/l; 4350 mg/l; 4400 mg/l; 4450 mg/l; 4500 mg/l; 4550 mg/l; 4600 mg/l; 4650 mg/l; 4700 mg/l; 4750 mg/l; 4800 mg/l; 4850 mg/l; 4900 mg/l; 4950 mg/l; and 5000 mg/l.

According to some embodiments of the above process the amount of the aquatic organism in the aquaculture tank is from 5 kg/m³ to 700 kg/m³.

According to some embodiments of the above process the amount of the aquatic organism in the aquaculture tank is from 5 kg/m³ to 700 kg/m³; 20 kg/m³ to 700 kg/m³; 50 kg/m³ to 700 kg/m³; 50 kg/m³ to 650 kg/m³; 100 kg/m³ to 650 kg/m³; 100 kg/m³ to 500 kg/m³; 100 kg/m³ to 700 kg/m³; 150 kg/m³ to 550 kg/m³; 100 kg/m³ to 650 kg/m³; 200 kg/m³ to 550 kg/m³; 200 kg/m³ to 400 kg/m³.

According to some embodiments of the above process the amount of the aquatic organism in the aquaculture tank is 5 kg/m³; 10 kg/m³; 20 kg/m³; 30 kg/m³; 40 kg/m³; 50 kg/m³; 60 kg/m³; 70 kg/m³; 80 kg/m³; 90 kg/m³; 100 kg/m³; 105 kg/m³; 110 kg/m³; 120 kg/m³; 130 kg/m³; 140 kg/m³; 150 kg/m³; 160 kg/m³; 170 kg/m³; 180 kg/m³; 190 kg/m³; 200 kg/m³; 205 kg/m³; 210 kg/m³; 220 kg/m³; 230 kg/m³; 240 kg/m³; 250 kg/m³; 260 kg/m³; 270 kg/m³; 280 kg/m³; 290 kg/m³; 300 kg/m³; 305 kg/m³; 310 kg/m³; 320 kg/m³; 330 kg/m³; 340 kg/m³; 350 kg/m³; 360 kg/m³; 370 kg/m³; 380 kg/m³; 390 kg/m³; 400 kg/m³; 405 kg/m³; 410 kg/m³; 420 kg/m³; 430 kg/m³; 440 kg/m³; 450 kg/m³; 460 kg/m³; 470 kg/m³; 480 kg/m³; 490 kg/m³; 500 kg/m³; 55 kg/m³; 510 kg/m³; 520 kg/m³; 530 kg/m³; 540 kg/m³; 550 kg/m³; 560 kg/m³; 570 kg/m³; 580 kg/m³; 590 kg/m³; 600 kg/m³; 605 kg/m³; 610 kg/m³; 620 kg/m³; 630 kg/m³; 640 kg/m³; 650 kg/m³; 660 kg/m³; 670 kg/m³; 680 kg/m³; 690 kg/m³; and 700 kg/m³.

In the context of the invention, the term “aquatic organism” refers, without limitation to an animal, whether invertebrate or vertebrate, that lives in water for most or all of its lifetime. The non-limiting list of the aquatic organisms of the invention includes: freshwater finfish, marine fish, estuarine fish, echinoderms, crustaceans, mollusks, or any other aquatic organism that can be grown in an aquaculture system that may benefit from the process of the invention.

According to some embodiments of the above process, the desired free gas CO₂ concentration in the aquaculture tank is from 0.5 mg/liter to 50 mg/liter. The free gas CO₂ can be measured using a sensor equipped with special permeable membrane for gases and then measuring infrared adsorption with non-dispersive infrared detection. Alternatively, the free CO₂ concentration maybe calculated from the water pH and carbonate alkalinity.

According to some embodiments of the above process, the desired free gas CO₂ concentration in the aquaculture tank is 0.5 mg/liter; 1 mg/liter; 2 mg/liter; 3 mg/liter; 4 mg/liter; 5 mg/liter; 6 mg/liter; 7 mg/liter; 8 mg/liter; 9 mg/liter; 10 mg/liter; 11 mg/liter; 12 mg/liter; 13 mg/liter; 14 mg/liter; 15 mg/liter; 116 mg/liter; 17 omg/liter; 18 mg/liter; 19 mg/liter; 20 mg/liter; 21 mg/liter; 22 mg/liter; 23 mg/liter; 24 mg/liter; 25 mg/liter; 26 mg/liter; 27 mg/liter; 28 mg/liter; 29 mg/liter; 30 mg/liter; 31 mg/liter; 32 mg/liter; 33 mg/liter; 34 mg/liter; 35 mg/liter; 36 mg/liter; 37 mg/liter; 38 mg/liter; 39 mg/liter; 40 mg/liter; 41 mg/liter; 42 mg/liter; 43 mg/liter; 44 mg/liter; 45 mg/liter; 46 mg/liter; 47 mg/liter; 48 mg/liter; 49 mg/liter; and 50 mg/liter.

According to some embodiments of the above process, the phrase “the aquaculture system is configured to remove CO₂ from the water” refers, without limitation to: pumping diffused air into the water, spraying water into the air, mechanically splashing the water surface, passing water through a column with or without surface media elements to disperse the water flow, combining the previous methods with forced air flow, and combining the previous methods with a negative pressure relative to atmospheric pressure (vacuum degassing).

According to some embodiments, the invention provides a method of aquaculture in a RAS system, comprising maintaining a desired free gas CO² concentration in an aquaculture tank, wherein the maintaining the desired free gas CO² concentration comprises adjusting alkalinity levels to the level of 150 mg/l to 5000 mg/l in the aquaculture tank by adding an alkalinity adjusting agent into the water. According to some embodiments of the above method, the alkalinity levels are adjusted to 150 mg/l to 5000 mg/l; 250 mg/l to 1000 mg/l; 500 mg/l to 1000 mg/1.

According to some embodiments of the above method, the alkalinity levels are adjusted to 150 mg/l; 200 mg/l; 250 mg/l; 300 mg/l; 350 mg/l; 400 mg/l; 450 mg/l; 500 mg/l; 550 mg/l; 600 mg/l; 650 mg/l; 700 mg/l; 750 mg/l; 800 mg/l; 850 mg/l; 900 mg/l; 950 mg/l; 1000 mg/l; 1150 mg/l; 1200 mg/l; 1250 mg/l; 1300 mg/l; 1350 mg/l; 1400 mg/l; 1450 mg/l; 1500 mg/l; 1550 mg/l; 1600 mg/l; 1650 mg/l; 1700 mg/l; 1750 mg/l; 1800 mg/l; 1850 mg/l; 1900 mg/l; 1950 mg/l; 2000 mg/l; 2150 mg/l; 2200 mg/l; 2250 mg/l; 22300 mg/l; 2350 mg/l; 2400 mg/l; 2450 mg/l; 2500 mg/l; 2550 mg/l; 2600 mg/l; 2650 mg/l; 2700 mg/l; 2750 mg/l; 2800 mg/l; 2850 mg/l; 2900 mg/l; 2950 mg/l; 3000 mg/l; 3150 mg/l; 3200 mg/l; 3250 mg/l; 3300 mg/l; 3350 mg/l; 3400 mg/l; 3450 mg/l; 3500 mg/l; 3550 mg/l; 3600 mg/l; 3650 mg/l; 3700 mg/l; 3750 mg/l; 3800 mg/l; 3850 mg/l; 3900 mg/l; 3950 mg/l; 4000 mg/l; 4150 mg/l; 4200 mg/l; 4250 mg/l; 4300 mg/l; 4350 mg/l; 4400 mg/l; 4450 mg/l; 4500 mg/l; 4550 mg/l; 4600 mg/l; 4650 mg/l; 4700 mg/l; 4750 mg/l; 4800 mg/l; 4850 mg/l; 4900 mg/l; 4950 mg/l; and 5000 mg/l.

According to some embodiments of the above method, the desired free gas CO₂ concentration in the aquaculture tank is from 0.5 mg/liter to 50 mg/liter.

According to some embodiments of the above method, the desired free gas CO₂ concentration in the aquaculture tank is 0.5 mg/liter; 1 mg/liter; 2 mg/liter; 3 mg/liter; 4 mg/liter; 5 mg/liter; 6 mg/liter; 7 mg/liter; 8 mg/liter; 9 mg/liter; 10 mg/liter; 11 mg/liter; 12 mg/liter; 13 mg/liter; 14 mg/liter; 15 mg/liter; 116 mg/liter; 17 mg/liter; 18 mg/liter; 19 mg/liter; 20 mg/liter; 21 mg/liter; 22 mg/liter; 23 mg/liter; 24 mg/liter; 25 mg/liter; 26 mg/liter; 27 mg/liter; 28 mg/liter; 29 mg/liter; 30 mg/liter; 31 mg/liter; 32 mg/liter; 33 mg/liter; 34 mg/liter; 35 mg/liter; 36 mg/liter; 37 mg/liter; 38 mg/liter; 39 mg/liter; 40 mg/liter; 41 mg/liter; 42 mg/liter; 43 mg/liter; 44 mg/liter; 45 mg/liter; 46 mg/liter; 47 mg/liter; 48 mg/liter; 49 mg/liter; and 50 mg/liter.

According to some embodiments, the invention provides a method of reaching a desired ratio of a biomass density to the amount of water processed through a water treatment process in an aquaculture tank, comprising adjusting alkalinity levels to the level of 150 mg/l to 5000 mg/l in the aquaculture tank by adding an alkalinity adjusting agent into the water, wherein the biomass is an aquatic organism biomass, and wherein the aquatic organism biomass produces free gas CO₂. In the context of the invention, the term “a water r treatment process” refers, without limitation, to a process whereby solid waste particles are removed, dissolved gasses are removed, and/or aquatic animal metabolic waste is removed. As used herein, the term “biomass” refers, without limitation, to the weight or total quantity of the aquatic organism according to the embodiments of the invention. In the context the invention the term “biomass density” refers, without limitation, to kg of fish in each cubic meter of fish tank water. The term “the amount of water processed through water treatment” is defined by stating the number of minutes required to replace 100% of the water in the fish tank. The desired ration between the biomass density to the amount of water processed through water treatment ranges from 20 minutes to 150 minutes.

According to some embodiments of the above method, the biomass density is measured as kilograms per aquaculture tank or kilograms per cubic meter. Thus, the ratio is further calculated by liters per hour of water flow per kilogram of biomass.

According to some embodiments of the above method, reaching desired ratio of a biomass density to the amount of water processed through a water treatment process in an aquaculture tank comprises reducing the amount of water processed through a water treatment process, without reducing the density of the biomass. For example, according to some embodiments of the invention, the water flow rate can be reduced to 10,000 liters per hour for an aquatic biomass of 1000 kilograms or a ratio of 10 liters per hour per kilogram of biomass. For example, according to some embodiments, the water flow rate can be reduced to 10 liters per hour per kilogram of biomass for fish with high tolerance to carbon dioxide to 30 liters per hour per kilogram for moderate tolerance and 60 liters per hour per kilogram for low tolerance.

According to some embodiments of the above method, reaching desired ratio of a biomass density to the amount of water processed through a water treatment process in an aquaculture tank comprises increasing the density of the biomass without increasing the amount of water processed through a water treatment process. For example, the amount of 1000 kilograms of fish can be increased to 1500 kilograms and with the improved biomass to water flow ratio of 6.67 liters per hour per kilogram of biomass, the 10,000 liters per hour water flow rate is sufficient for optimum performance.

According to some embodiments of the above method, the amount of biomass placed in the aquaculture tank is from 5 kg/m³ to 700 kg/m³.

According to some embodiments of the above method, the amount of biomass placed in the aquaculture tank is 5 kg/m³; 10 kg/m³; 20 kg/m³; 30 kg/m³; 40 kg/m³; 50 kg/m³; 60 kg/m³; 70 kg/m³; 80 kg/m³; 90 kg/m³; 100 kg/m³; 105 kg/m³; 110 kg/m³; 120 kg/m³; 130 kg/m³; 140 kg/m³; 150 kg/m³; 160 kg/m³; 170 kg/m³; 180 kg/m³; 190 kg/m³; 200 kg/m³; 205 kg/m³; 210 kg/m³; 220 kg/m³; 230 kg/m³; 240 kg/m³; 250 kg/m³; 260 kg/m³; 270 kg/m³; 280 kg/m³; 290 kg/m³; 300 kg/m³; 305 kg/m³; 310 kg/m³; 320 kg/m³; 330 kg/m³; 340 kg/m³; 350 kg/m³; 360 kg/m³; 370 kg/m³; 380 kg/m³; 390 kg/m³; 400 kg/m³; 405 kg/m³; 410 kg/m³; 420 kg/m³; 430 kg/m³; 440 kg/m³; 450 kg/m³; 460 kg/m³; 470 kg/m³; 480 kg/m³; 490 kg/m³; 500 kg/m³; 55 kg/m³; 510 kg/m³; 520 kg/m³; 530 kg/m³; 540 kg/m³; 550 kg/m³; 560 kg/m³; 570 kg/m³; 580 kg/m³; 590 kg/m³; 600 kg/m³; 605 kg/m³; 610 kg/m³; 620 kg/m³; 630 kg/m³; 640 kg/m³; 650 kg/m³; 660 kg/m³; 670 kg/m³; 680 kg/m³; 690 kg/m³; and 700 kg/m³.

According to some embodiments, the invention provides a method of aquaculture comprising maintaining the free gas CO₂ concentration produced by a biomass of aquatic organisms under a desired threshold by adjusting alkalinity levels to the level of 150 mg/l to 5000 mg/l in an aquaculture tank by adding an alkalinity adjusting agent into the water. According to some embodiments of the above method, the alkalinity levels are adjusted to 150 mg/l to 5000 mg/l; 250 mg/l to 1000 mg/l; 500 mg/l to 1000 mg/l.

According to some embodiments of the above method, the alkalinity levels are adjusted to 150 mg/l; 200 mg/l; 250 mg/l; 300 mg/l; 350 mg/l; 400 mg/l; 450 mg/l; 500 mg/l; 550 mg/l; 600 mg/l; 650 mg/l; 700 mg/l; 750 mg/l; 800 mg/l; 850 mg/l; 900 mg/l; 950 mg/l; 1000 mg/l; 1150 mg/l; 1200 mg/l; 1250 mg/l; 1300 mg/l; 1350 mg/l; 1400 mg/l; 1450 mg/1; 1500 mg/l; 1550 mg/l; 1600 mg/l; 1650 mg/l; 1700 mg/1; 1750 mg/l; 1800 mg/l; 1850 mg/l; 1900 mg/l; 1950 mg/1; 2000 mg/l; 2150 mg/l; 2200 mg/l; 2250 mg/l; 22300 mg/l; 2350 mg/l; 2400 mg/l; 2450 mg/l; 2500 mg/l; 2550 mg/l; 2600 mg/l; 2650 mg/l; 2700 mg/l; 2750 mg/l; 2800 mg/l; 2850 mg/l; 2900 mg/l; 2950 mg/l; 3000 mg/l; 3150 mg/l; 3200 mg/l; 3250 mg/l; 3300 mg/l; 3350 mg/l; 3400 mg/l; 3450 mg/l; 3500 mg/l; 3550 mg/l; 3600 mg/l; 3650 mg/l; 3700 mg/l; 3750 mg/l; 3800 mg/l; 3850 mg/l; 3900 mg/l; 3950 mg/l; 4000 mg/l; 4150 mg/l; 4200 mg/l; 4250 mg/l; 4300 mg/l; 4350 mg/l; 4400 mg/l; 4450 mg/l; 4500 mg/l; 4600 mg/l; 4550 mg/l; 4650 mg/l; 4700 mg/l; 4750 mg/l; 4800 mg/l; 4850 mg/l; 4900 mg/l; 4950 mg/l; and 5000 mg/l.

According to some embodiments of the above method, the desired threshold of free gas CO₂ concentration produced by a biomass of aquatic organisms is 0.5 mg/liter to 50 mg/liter.

According to some embodiments of the above method, the desired threshold of free gas CO₂ concentration produced by a biomass of aquatic organisms is 0.5 mg/l; 1 mg/l; 1.5 mg/l; 2 mg/l; 2.5 mg/l; 3 mg/l; 3.5 mg/l; 4 mg/l; 4.5 mg/l; 5 mg/l; 5.5 mg/l; 6 mg/l; 6.5 mg/l; 7 mg/l; 7.5 mg/l; 8 mg/l; 8.5 mg/l; 9 mg/l; 9.5 mg/l; 10 mg/l; 11 mg/l; 12 mg/l; 13 mg/l; 14 mg/l; 15 mg/l; 16 mg/l; 17 mg/l; 18 mg/l; 19 mg/l; 20 mg/l; 21 mg/l; 22 mg/l; 23 mg/l; 24 mg/l; 25 mg/l; 26 mg/l; 27 mg/l; 28 mg/l; 29 mg/l; 30 mg/l; 31 mg/l; 32 mg/l; 33 mg/l; 34 mg/l; 35 mg/l; 36 mg/l; 37 mg/l; 38 mg/l; 39 mg/l; 40 mg/l; 41 mg/l; 42 mg/l; 43 mg/l; 44 mg/l; 45 mg/l; 46 mg/l; 47 mg/l; 48 mg/l; 49 mg/l; and 50 mg/l.

According to some embodiments, the above process can be performed under and influenced to some extent by temperature, salinity, or any other relevant parameter.

### Example 1: Alkalinity Adjustment for Increasing the CO₂ Stripping Capacity

Tests were conducted in a gas stripping column by adjusting the alkalinity in a tank to: 100 mg/l, 120 mg/l, 230 mg/l, and 350 mg/l with the free dissolved CO₂ concentration adjusted to 12 mg/l with pure CO₂, simulating addition of CO₂ by aquaculture biomass in the tank. Then the quantity of CO₂ removed in the gas stripping element was measured at each alkalinity concentration. The above quantity of CO₂ that can then be added by the fish, then removed in the gas stripping thereby managing the dissolved free gas CO₂ concentration at 12 mg/l for this example.

### Results

The quantity, mg/l, of CO₂ removed increased from 10 mg/l at the concentrations of alkalinity used in aquaculture prior art to 21 mg/l with alkalinity adjusted to 350 mg/l. The increased CO₂ removal capability allows the increasing aquaculture biomass, thereby increasing the quantity of CO₂ that can be added and removed in managing an aquaculture system with a desired CO₂ limit of 12 mg/l, as represented in Table 1.

TABLE 1
Increased CO₂ stripping capability with increased
carbonate alkalinity.
Table 1: Increased CO2 stripping capability with
increased carbonate alkalinity.

| | | | Tank | |
|---|---|---|---|---|
| | Carbonate | Tank | Inlet | CO₂ Added |
| RAS | Alkalinity | CO₂ | CO₂ | and removed |
| Example | mg/liter | mg/l | mg/l | mg/l per hr |
| Prior Art | 100 | 12 | 2.0 | 10 |
| RAS A | 120 | 12 | 1.5 | 11 |
| RAS B | 230 | 12 | 1.5 | 14 |
| RAS C | 350 | 12 | 1.5 | 21 |

The terminology used herein is for the purpose of describing particular embodiments only and is not intended to be limiting of the invention.

As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof. As used herein the terms “comprises”, “comprising”, “includes”, “including”, “having” and their conjugates mean “including but not limited to”. The term “consisting of” means “including and limited to”.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section.

It will be understood that when an element is referred to as being “on,” “attached” to, “operatively coupled” to, “operatively linked” to, “operatively engaged” with, “connected” to, “coupled” with, “contacting,” “added to” etc., another element, it can be directly on, attached to, connected to, operatively coupled to, operatively engaged with, coupled with, added to, and/or contacting the other element or intervening elements can also be present. In contrast, when an element is referred to as being “directly contacting” another element or “directly added” to another element, there are no intervening elements and/or steps present.

Whenever the term “about” is used, it is meant to refer to a measurable value such as an amount, a temporal duration, and the like, and is meant to encompass variations of ±20%, ±10%, ±5%, ±1%, or ±0.1% from the specified value, as such variations appropriate to perform the disclosed methods.

Certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Throughout this application, various embodiments of this invention may be presented in a range format. It should be understood that the description in range format is merely for convenience and brevity and should not be construed as an inflexible limitation on the scope of the invention. Accordingly, the description of range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

Whenever terms “plurality” and “a plurality” are used it is meant to include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, biological, biochemical, and veterinary arts.

All publications, patent applications, patents, and other references mentioned. The disclosures of these publications in their entireties are hereby incorporated by reference into this application in order to more fully describe the state of the art to which this invention pertains. In case of conflict, the specification, including patent definitions, will prevail. In addition, the materials, methods, and examples are illustrative only and not intended to be limiting. Throughout this application various publications, published patent applications and published patents are referenced.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description. While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention. Various embodiments have been presented. Each of these embodiments may of course include features from other embodiments presented, and embodiments not specifically described may include various features described herein.

1. A process of maintaining a desired free gas CO₂ concentration in an aquaculture tank of an aquaculture system, comprising adjusting alkalinity levels to the level of 150 mg/l to 5000 mg/l in the aquaculture tank by adding an alkalinity adjusting agent into the tank, wherein the aquaculture tank comprises an amount of an aquatic organism, and wherein said aquatic organism produces free gas CO₂, and wherein the aquaculture system is configured to remove CO₂ from the water.

2. The process of claim 1, wherein the alkalinity adjusting agent is selected from the group consisting of sodium bicarbonate, sodium hydroxide, sodium carbonate, calcium hydroxide, calcium oxide, calcium carbonate, dolomite magnesium hydroxide, and magnesium carbonate.

3. The process of claim 1, wherein the alkalinity level is adjusted to 250 mg/l to 1000 mg/l.

4. The process of claim 1, wherein the alkalinity level is adjusted to 500 mg/l to 1000 mg/l.

5. The process of claim 1, wherein the amount of the aquatic organism in the aquaculture tank is from 5 kg/m³ to 700 kg/m³

6. The process of claim 1, wherein desired free gas CO₂ concentration in the aquaculture tank is from 0.5 mg/liter to 50 mg/liter.

7. The process of claim 1, wherein the aquatic organism is selected from the group consisting of freshwater finfish, marine fish, estuarine fish, echinoderms, crustaceans, and mollusks.

8. A method of aquaculture in a RAS system, comprising maintaining a desired free gas CO₂ concentration in an aquaculture tank, wherein the maintaining the desired free gas CO₂ concentration comprises adjusting alkalinity levels to the level of 150 mg/l to 5000 mg/l in the aquaculture tank by adding an alkalinity adjusting agent into the water.

9. The method of claim 8, wherein the alkalinity adjusting agent is selected from the group consisting of sodium bicarbonate, sodium hydroxide, sodium carbonate, calcium hydroxide, calcium oxide, calcium carbonate, dolomite magnesium hydroxide, and magnesium carbonate.

10. The method of claim 8, wherein water alkalinity level is 250 mg/l to 1000 mg/l.

11. The method of claim 8, wherein water alkalinity level is 500 mg/l to 1000 mg/l.

12. A method of reaching a desired ratio of a biomass density to the amount of water processed through a water treatment process in an aquaculture tank, comprising adjusting alkalinity levels to the level of 150 mg/l to 5000 mg/l in the aquaculture tank by adding an alkalinity adjusting agent into the water, wherein the biomass is an aquatic organism biomass, and wherein the aquatic organism biomass produces free gas CO₂.

13. The method of claim 12, wherein reaching desired ratio of a biomass density to the amount of water processed through a water treatment process in an aquaculture tank comprises reducing the amount of water processed through a water treatment process, without reducing the density of the biomass.

14. The method of claim 12, wherein reaching desired ratio of a biomass density to the amount of water processed through a water treatment process in an aquaculture tank comprises increasing the density of the biomass without increasing the amount of water processed through a water treatment process.

15. The method of claim 12, wherein the aquatic organism biomass is selected from the group consisting of freshwater finfish, marine fish, estuarine fish, echinoderms, crustaceans, and mollusks.

16. The method of claim 12, wherein the alkalinity adjusting agent is selected from the group consisting of sodium bicarbonate, sodium hydroxide, sodium carbonate, calcium hydroxide, calcium oxide, calcium carbonate, dolomite magnesium hydroxide, and magnesium carbonate.

17. The method of claim 12, wherein the alkalinity level is adjusted to 250 mg/l to 1000 mg/l.

18. The method of claim 12, wherein water alkalinity level is adjusted to 500 mg/l to 1000 mg/l.

19. The method of claim 12, wherein the amount of biomass placed in the aquaculture tank is from 5 kg/m³ to 700 kg/m³.

20. (canceled)
